(19) United States
(12) Patent Application Publication
(10) Pub. No.: US 2008/0095647 A1
(43) Pub. Date: Apr. 24, 2008

(54) Fluid-Pressure Generator

(76) Inventors: Andreas Grundl, Munich (DE); Bernhard Hoffmann, Starnberg (DE)

Correspondence Address: HISCOCK & BARCLAY, LLP, 2000 HSBC PLAZA, 100 Chestnut Street, ROCHESTER, NY, 14604-2404, US

(21) Appl. No.: 11/577,679

(22) PCT Filed: Sep. 19, 2005
(86) PCT No.: PCT/EP05/10100

§ 371 Date: Sep. 20, 2007

(30) Foreign Application Priority Data
Oct. 20, 2004 (DE) 10 2004 051 138.1

(51) Int. Cl. F04B 17/04; F02M 57/02; F04B 53/10

(52) U.S. Cl. 417/417

(57) ABSTRACT

A fluid-pressure generator, in order to generate a high pressure-level in fluids at high speed in a small construction space, with an inlet which is adapted to receive fluid from a supply line, with an electrically triggerable actuating device which is adapted to interact with an ejection-valve arrangement in order to allow fluid to flow out through a fluid outlet, wherein the fluid outlet is connected to a chamber by a flow duct, a displaceable piston, which is provided for the purpose of changing the volume of the chamber, projects into the chamber, and the piston is to be actuated by an electromagnet arrangement in the sense of a diminution of volume, the electromagnet arrangement exhibiting a stator and an armature, and the stator taking the form of a multipole stator which exhibits one or more excitation coils assigned to the respective stator poles.

### BACKGROUND OF THE INVENTION

The invention relates generally to a fluid-pressure generator, for example for the direct injection of fuel into a combustion space of an internal-combustion engine. In principle, it is possible to make use of the invention both in engines injecting directly and in conventional engines injecting into the intake manifold. However, the field of application of the invention is not restricted to fuel-injection systems. The invention may also be employed in other fields of application in which the generation of pressure in fluids to a high pressure-level at high speed in a small construction space is required or desirable.

The invention will be elucidated below on the basis of a pressure-generator for a fuel-injection system.

Arising out of steadily increasing requirements of exhaust-gas legislation, with limits falling further, the resulting challenge is to optimise the formation of noxious substances at the site of their formation through an optimisation of the process of injection of fuel into the combustion chamber. Critical, in particular, are emissions of NOₓ and soot. By virtue of the development of injection systems having ever higher injection pressures and highly dynamic injectors, and also by virtue of cooled exhaust-gas recirculation and oxidation catalysts, it is in fact possible to comply with current limits. However, the potential of the previous measures for reducing emissions appears to have been reached.

For clean combustion it is important to atomise the fuel particularly finely. At an injection pressure of, for example, approximately 200 bar the average diameter of the fuel droplets amounts to only about 15 thousandths of a millimetre.

### STATE OF THE ART

In the state of the art, so-called “common rail” systems are known which are also designated in German as Speichereinspritzsysteme (storage injection systems). In the common-rail system the generation of pressure and the injection of fuel are totally decoupled from one another. A separate high-pressure pump continuously generates pressure in the fuel supply line for all the injection valves of an internal-combustion engine. Hence the fuel pressure is built up independently of the injection sequence and is permanently available in the fuel line. The constantly queued high pressure of more than 1350 bar is stored in the so-called rail and is made available to the injectors of a cylinder bank of the internal-combustion engine via short injection lines. The time of injection and the quantity of fuel are calculated individually for each cylinder and injected [sic] via rapidly-switching solenoid-operated valves (injectors).

In this connection the high-pressure pump is a central element which is critical for the operation of the common-rail system. In the state of the art, three-piston pumps with a central eccentric, or double-disc radial-piston pumps, generally come into operation. High-pressure pumps of such a type are costly. The lines and the seals between the high-pressure pump and the individual injectors also have to be designed for this high pressure. In addition, it is necessary to provide a return flow of fuel from each individual injector to the high-pressure pump, or to the fuel reservoir, with a fuel cooling system. Moreover, it is necessary for the fuel pressure in the rail to be adjusted by a pressure-regulating valve and monitored by a rail-pressure sensor. This represents a considerable effort in terms of apparatus, which makes such common-rail systems very expensive. In addition, these systems are also burdened with risk, on account of the high pressure. For instance, in principle no high-pressure lines are permitted to be disconnected when the engine is running. If the opening of the high-pressure circuit in a common-rail system is necessary, waiting-times for the purpose of reducing the system pressure have to be observed after the engine has been switched off. More recent common-rail injection systems with a volume-controlled high-pressure pump are still under high pressure even up to five minutes after the internal-combustion engine has been switched off.

Moreover, so-called pump/nozzle injection systems are known in the state of the art. In this connection the fuel-injection pump and the injection nozzle for each cylinder of the internal-combustion engine are combined in a single structural component. This means that the high pressure (about 2000 bar) is generated separately at the injection element of each cylinder. Mounted in the cylinder head of each cylinder is a pump/nozzle injection element, and the pump pistons are driven by the camshaft of the internal-combustion engine via rocker arms. The feed and return of fuel are effected via ducts integrated within the cylinder head. Via the rocker arm and a plunger-return spring the camshaft brings about a defined stroke for each piston. In the course of an upward motion of the piston the fuel flows from the cylinder head through a control valve into a chamber situated beneath the plunger. At a point in time determined by a control device, an electrical impulse energises the control valve, in order to close the latter. The plunger now travels downwards and thereby brings about a rapid rise in the pressure in the pressure ducts. At a predetermined pressure the nozzle opens and the injection begins. If the control valve is currentless, it opens. As a result, the pressure breaks down, the nozzle closes, and the injection is concluded.

On account of the separate rocker arms on each cylinder head, this system is mechanically very elaborate. In addition, the pressure curve—or, to be more exact, the opening-pressure of the nozzle—can only be controlled with difficulty.

From U.S. Pat. No. 6,032,341 B1 a fuel injector is known in which two electromagnetic coils are arranged along a fuel line. Two spindles are resiliently supported by two springs and are capable of being moved back and forth by the electromagnetic coils. The two spindles open and close the inlet and outlet, respectively, of the fuel. The interaction of the two electromagnetic coils with the two spindles is controlled in such a way that fuel having a defined, constant pressure flows into the arrangement and is able to flow out in controlled manner. In principle, this arrangement functions like a lock or sluice. An increase in pressure or a conveying effect is not brought about by the arrangement that is known from this document. In addition, with this arrangement no check valve is provided. Lastly, the stator here is also not arranged in the interior of the precombustion chamber. From DE 29 46 577 A1 a fuel-injection system is known which takes the form of a combination of pump and fuel injector. In a cylinder a pump plunger is slidably arranged which is to be actuated by means of an electromagnetic mechanism in the sense of a displacement of the fuel out of the cylinder. The cylinder has a fuel inlet, through which fuel is able to flow into the cylinder during the return motion of the pump plunger. In operation, the armature moves in the direction of the fuel outlet when the electromagnet is energised, and in the process imparts an axial motion to the pump plunger. This motion of the pump plunger pressurises the fuel contained in the cylinder. As soon as a sufficiently high pressure has been attained, a valve head lifts off from its seat, and fuel flows into the combustion space of the engine. When the electromagnet is de-energised, a spring transports the plunger and the armature of the electromagnet back into their initial positions, and fuel flows into the cylinder via a check valve. The valve head returns to its seat if the pressure in the cylinder is reduced. From DE 890 307 C an electromagnetic piston pump is known in which, in two hollow cylindrical solenoid coils situated side by side at the front, an iron core which is received in longitudinally displaceable manner actuates a piston rod which acts on a hollow piston which has an inlet valve in its base.

From DE 29 46 632 A1 an injection-pump valve for supplying fuel into the combustion chamber of an internal-combustion engine is known which has a housing which is stepped in hollow cylindrical manner and at the end of which projecting into the combustion chamber a nozzle tip is arranged. The nozzle tip has a central longitudinal bore in which a valve actuator is arranged which, together with a seat located in the bore, forms an outlet valve. Located furthermore in the housing is an electromagnetic unit which ads on a piston which serves to displace fuel. The fuel is subjected to the piston pressure in the cylinder, and this pressure acts on the head of a valve actuator, so that the head lifts off from its seat if the pressure in the fuel is sufficiently high.

From GB 2 196 701 A a fuel-injection pump is known in which a solenoid-coil arrangement is arranged in several concentrically extending grooves and acts on a plate-shaped armature. The armature is connected via a valve coil to a valve member which together with a valve seat forms a stop valve.

From U.S. Pat. No. 1,534,829 an electrically actuated injection valve is known in which a fuel pump is formed by two cylindrical magnetic coils which each enclose an iron core. The two iron cores interact with an armature which is fastened to a domed membrane plate. The membrane plate delimits a cavity with an inlet and an outlet, in each of which a check valve is arranged, so that in the event of a movement of the membrane plate a pumping action arises by virtue of the magnetic coils; in the event of current being supplied to the magnetic coils, the cavity decreases in size if the membrane is attracted by the magnetic coils, and the cavity is enlarged if the membrane returns to its initial position when the magnetic coils are de-energised.

An electromagnetic actuating mechanism with a yoke body made of electrically conducting material is known from DE 26 21 272 C2. This mechanism has an annular induction coil arranged in the interior of the yoke body and made of two serially arranged similar windings which are capable of being energised with a d.c. control current, with opposed sense of winding, and with an armature arranged concentrically within the induction coil, said armature consisting of a permanent magnet. At the axial ends of said permanent magnet there are located pole pieces, the induction coil being longer than the armature, the induction coil being firmly arranged in the housing, and the armature being arranged in the housing in mobile manner. On the one side of the armature there is mounted a magnet with constant magnetisation, and on the other side there is mounted a yoke element made of magnetically conducting material, in such a way that the repelling force between the magnet and the armature and the attracting force between the yoke element and the armature add so as to result in a total force that is as constant as possible over the stroke of the armature.

### Problem Underlying the Invention

The problem underlying the invention is to overcome the disadvantages of the aforementioned known systems at least partly and also to make available an inexpensive arrangement, of compact construction, of a fluid-pressure generator that is capable of generating a high pressure-level in fluids at high speed in a small construction space.

### Solution According to the Invention

The invention solves this problem by means of a fluid-pressure generator, in order to generate a high pressure-level in fluids at high speed in a small construction space, with an inlet which is adapted to receive fluid from a supply line and which is connected to a chamber, with a fluid outlet which is connected to the chamber and which is adapted to allow fluid to flow out of the fluid-pressure generator, with a displaceable piston projecting into the chamber, which is provided for the purpose of changing the volume of the chamber, and with an electromagnet arrangement by means of which the piston is to be actuated in the sense of a diminution of volume. According to the invention, the electromagnet arrangement exhibits a stator and an armature, the stator taking the form of a multipole stator with one or more stator poles and exhibiting excitation coils assigned to the respective stator poles.

The term ‘multipole stator’ in the sense of the present invention is to be understood to mean an arrangement of two or more pole bars which are cylindrical (e.g. round or oval) or polygonal (e.g. triangular, quadrangular or hexagonal) in cross-section and which are arranged on a surface, for example on a plane, and surrounded by one or more coil arrangements. In this connection a specific coil arrangement may be assigned to each pole bar, or a coil arrangement may be wound around several pole bars.

This permits the generation of a high magnetic-force density which manifests itself in a very rapidly building and reducing magnetic field and in a high hydraulic pressure in the fluid. In this connection the generated pressure is independent of any counterpressure which may exist, since the fluid-pressure generator according to the invention displaces the fluid for the purpose of building up the pressure.

In similar manner, the armature may also take the form of a multipole armature, the armature poles of which are oriented towards the respective stator poles. In this connection the armature poles may be formed by diminutions or thickenings of the armature plate which otherwise substantially follows the contour of the end face of the totality of all the pole bars.

Between the stator and the armature the electromagnet arrangement has a working air gap which is preferably oriented substantially transversely relative to the direction of motion of the armature. However, it is also possible to orient the working air gap differently, depending on the given spatial conditions.

By virtue of the configuration, according to the invention, of the fluid-pressure generator, it is possible to manage without the long high-pressure lines of the common-rail system, since the high pressure is generated locally—i.e. in the immediate vicinity of the fuel injector. This significantly reduces the requirements as regards the fuel-supply lines. In addition, it is not necessary for the high pressure to be kept up permanently. Rather it is sufficient to raise the pressure a short time before the (first) injection operation of the entire injection cycle of the internal-combustion engine. In this connection it is of course possible, and within the scope of the present invention, to offset the fluid-pressure generator according to the invention from the actual valve by means of a line. Equally, the limitation of pump/nozzle systems does not exist, in which the expenditure, in terms of apparatus, on the rocker-arm arrangements is required, with appropriate installation and adjustment.

The invention permits, moreover, the high pressure generated in the fluid to be left practically constant during a predetermined period, for example during one injection cycle. In the case of fuel-injection valves, this ensures an optimally fine and rapid atomisation of the fuel in the cylinder of the internal-combustion engine. However, it is also possible to change the high pressure of the fluid during a predetermined period, for example during one injection cycle, by variation of the excitation current of the electromagnet arrangement acting on the piston, should this be desirable. This possibility is offered neither by the conventional pump/nozzle system nor by the common-rail system. A further merit of the arrangement according to the invention consists in that—other than in the pump/nozzle system—the generation of the pressure in the fluid is effected independently of the actuation of the injector. To this end, in accordance with the invention in one type of embodiment two actuators to be triggered independently of one another are provided in the form of the electrically triggerable actuating device for an injection-valve arrangement, on the one hand, and in the form of the electromagnet arrangement for actuating the piston in the sense of a diminution in volume of the chamber, on the other hand. In this case the injection-valve arrangement may also be an injection valve that opens automatically at a defined excess pressure and that has no metering function. Rather, such an injection valve opens and closes at a frequency determined by a spring and by other mechanical components. But, alternatively, in the case of the injection-valve arrangement it may also be a question of an electromagnetic injection valve that is formed substantially from a valve body with current coil and electrical terminals, in which case a valve seat with injection-orifice disc is arranged in the valve body, in which, or from which, valve seat a valve needle, driven by a magnet armature, engages or disengages.

The invention takes advantage of the principle of providing between the fluid inlet and the actual fuel injector—that is to say, the injector-valve arrangement—a local, compact pressure-generator arrangement for a small fluid volume (for example, the quantity of fuel of an injection operation) which is to be subjected to a high pressure for a short period (for example, for the duration of an injection operation). To this end, the pressure-generator arrangement is provided with a chamber, into which a piston plunges, and also with the electromagnet arrangement for actuating the piston.

### FURTHER DEVELOPMENTS AND CONFIGURATIONS OF THE INVENTION

In a first configuration of the fuel-injection valve according to the invention a check valve is provided, by means of which an emergence of fluid located in the chamber in the direction of the fluid inlet is prevented. In this connection the check valve may be arranged in a flow duct from the fluid inlet to the chamber, or may be arranged in the displaceable piston. In a currently preferred embodiment of the invention, the check valve is arranged in a fluid conduit located in the piston. According to the invention, the electromagnet arrangement has a stator and an armature, the armature being connected firmly, or by means of a transmission, to the displaceable piston. As an alternative, the piston may also be an integral part of the armature.

In a first embodiment of the invention, the stator and/or the armature is/are arranged in the interior of a chamber. This has the advantage that no pressure-resistant lines and seals have to be provided between the low-pressure region (approximately up to 20 bar fluid pressure) and the high-pressure region (approximately 100 bar-3000 bar fluid pressure). Rather, in this case an encapsulated embodiment is possible in which all the components are accommodated. In an alternative configuration, the pressure-generator and the electromagnet arrangement for actuating the piston may be spatially separated to such an extent that the piston or an actuating member of the piston is provided between the two assemblies—the electromagnetic arrangement, on the one hand, and the chamber with fluid inlets and outlets. In order to enable a flow of fuel that is as unhindered as possible, the stator and/or armature has/have at least one fluid duct for fluid in the direction towards the valve arrangement.

In order that, after completion of an ejection of fluid (for example, after an injection cycle), new fluid is aspirated again into the chamber for the purpose of building up the pressure for a subsequent ejection operation, or in order that the displaceable piston moves back again into its initial position, in one embodiment of the invention a magnet arrangement, preferably exhibiting permanent magnets, may be provided on a side of the armature remote from the stator, which pulls the armature into the inoperative position thereof and in the process moves the piston out of the chamber in the sense of an enlargement of the volume of the chamber. However, instead of the permanent magnets, or in addition to the latter, it would also be possible to use an electromagnet arrangement, to be appropriately supplied with current, in order to move the piston out of the chamber.

According to the invention, the chamber for the build-up of pressure, the piston and the electromagnet arrangement may be configured together with the valve arrangement in the form of an assembly that is capable of being manipulated jointly.

The actuating device of the injector (that is to say, of the injection element) acts on a movable valve member of the valve arrangement, in order to move said valve member between an open position and a closed position in relation to a fixed valve seat interacting with the valve member and arranged downstream relative to the fluid inlet.

In order to realise particularly slender or elongated designs with large holding forces or closing forces, a cascading of several actuating devices acting on the valve arrangement, and/or of several electromagnet arrangements acting on the piston, may be undertaken. In this connection the actuating devices may act jointly on the valve arrangement—either in the same direction or in opposing directions. Corresponding remarks apply to the electromagnet arrangements acting on the piston.

According to the invention, in one embodiment of the invention an actuator for the valve arrangement is provided which acts on a movable valve member, in order to move the latter between an open position and a closed position in relation to a fixed valve seat interacting with the valve member and arranged downstream relative to the fluid inlet. Hence a valve arrangement that switches directly can be realised.

In another configuration of the fluid-pressure generator according to the invention, the actuator of the valve device acts on a movable valve member, in order to move the latter between an open position and a closed position in relation to a fixed valve seat interacting with the valve member. Hence a controlled discharging of fluid (fuel) into a return line is made possible if a second, spring-loaded valve member together with a second valve seat is not opened by virtue of the pressure prevailing in the space to be charged (for example, a combustion space), and a controlled discharging of fluid (fuel) into this space is made possible if the second, spring-loaded valve member together with the second valve seat is opened by virtue of the pressure prevailing in the space. Hence a valve arrangement that switches indirectly can be realised.

The fluid-pressure generator according to the invention may be configured, adapted and dimensioned as a fuel-injection-valve arrangement, in order to project into the combustion space of a spark-ignited internal-combustion engine or into the combustion space of a self-igniting internal-combustion engine.

Further advantages, configurations or variation possibilities will become apparent from the following description of the Figures in which the invention is elucidated in detail.

### BRIEF DESCRIPTION OF THE FIGURES

FIG. 1 shows a schematic representation in longitudinal section through a fluid-pressure generator according to a first embodiment of the invention.

FIG. 1a shows a schematic representation in cross-section through a fluid-pressure generator along line Ia-Ia in FIG. 1.

FIG. 2 shows a schematic representation in longitudinal section through a fluid-pressure generator according to a second embodiment of the invention.

FIG. 3 shows a schematic representation of the operation of the fluid-pressure generator according to the invention in the form of a graphical curve.

FIG. 4 shows a schematic representation in longitudinal section through a fluid-pressure generator according to a further embodiment of the invention.

FIG. 5 shows a schematic representation in longitudinal section through an injection-valve arrangement according to a further embodiment of the invention.

FIGS. 6, 6a and 6b show further schematic representations in longitudinal section through additional embodiments of fluid-pressure generators according to the invention.

FIGS. 7 and 8 show schematic representations in longitudinal section of injection-valve arrangements that are suitable for use within the scope of the invention.

### DETAILED DESCRIPTION OF CURRENTLY PREFERRED EMBODIMENTS

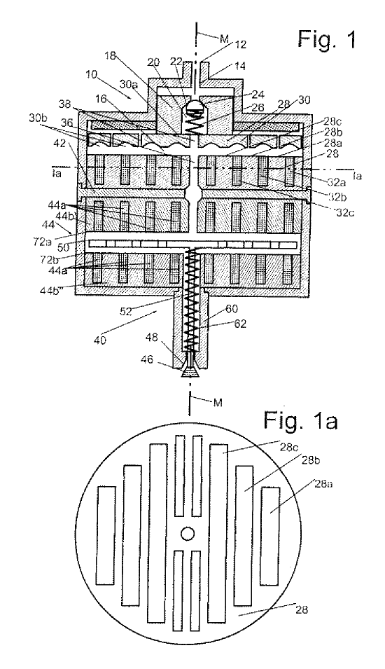

In FIG. 1 a fluid-pressure generator, with a housing 10 which is substantially rotationally symmetrical relative to a central longitudinal axis M, is shown in schematic longitudinal section in a half-open position. A fluid-pressure generator of such a type may serve for pressurising fluid in the form of fuel, in order to inject it directly into the combustion space, not illustrated in any detail, of an internal-combustion engine. The fluid-pressure generator has (at the top in FIG. 1) a central fluid inlet 12, through which fluid from a fluid-distributing line is able to flow into the fluid-pressure generator. However, it is also possible to provide the fluid inlet 12 at the side in the upper region of the fuel-injection valve in FIG. 1. From the fluid inlet 12 a central fuel duct 14 extends to a chamber 16. The central fluid duct 14 has a circular cross-section and is widened towards the chamber 16. In the widened section of the fluid duct 14 a circular cylindrical piston 18 which projects into the chamber 16 is guided in displaceable and fluid-tight manner. As a result of a displacement of the piston 18 along the central longitudinal axis M, the volume of the chamber 16 is changed. If the piston 18 plunges into the chamber 16 along the central longitudinal axis M, the volume of said chamber diminishes, so that the pressure acting on a fluid located therein increases. If the piston 18 is moved out of the chamber 16, the volume of said chamber increases, so that the pressure acting on a fluid located therein diminishes.

Arranged centrally in the piston 18 is a fluid conduit 20 which widens conically—viewed in the direction of flow of the fluid—in order to form a valve seat 22 for a valve member 24 configured as a ball, which is pushed against the valve seat 22 by means of a helical spring 26. Hence a check valve 22, 24, 26 is formed, by means of which an emergence of fluid located in the chamber 16 in the direction of the fluid inlet 12 is prevented.

The piston 18 is to be actuated by an electromagnet arrangement in the sense of a diminution of volume. To this end, the electromagnet arrangement 28, 30, 32 has a stator 28 arranged in the interior of the chamber 16 and formed from soft iron (plates) having a substantially circular cylindrical shape, and a substantially circular cylindrical disc-shaped armature 30 likewise arranged in the interior of the chamber 16. On its one (upper in FIG. 1) end face 30a the armature 30 is rigidly connected to the displaceable piston 18. In this connection the stator 28 takes the form of a multipole stator with elongated stator poles 28a, 28b, 28c arranged alongside one another with a spacing (see also FIG. 1a). Several excitation coils 32a, 32b, 32c are assigned to the respective stator poles 28a, 28b, 28c, surrounding the latter. Equally, the armature 30 may take the form of a multipole armature, the armature poles of which are oriented towards the respective stator poles. Hence the armature 30, and with it the piston 18, is able to move along the central longitudinal axis M. Between the stator 28 and the armature 30 there is formed a working air gap 34 oriented transversely relative to the direction of motion of the armature 30. In this connection the difference between the minimal and the maximal extent of the working air gap constitutes the measurement by which the displaceable piston 18 plunges into the chamber and pressurises fluid located therein.

As illustrated in FIG. 1a, the multipole stator 28 has an arrangement of several polygonal pole bars 28a, 28b, 28c, which are cylindrical in cross-section or in top view and which are arranged on a surface. These pole bars, which in the present example are rectangular, may also be of substantially quadratic or trapezoidal shape in top view. They are surrounded by one or more coil arrangements. In this connection, in the present embodiment of the invention there is assigned to each pole bar a specific coil arrangement which surrounds it. However, it is also possible for a coil arrangement to be wound around several pole bars. On account of the better overall view, in FIG. 1a the coil arrangements have been omitted. However, it will be understood that the coil arrangements divide, where appropriate, the space between two adjacent pole bars.

The stator 28 and the armature 30 each have one or more fluid ducts 36, 38, in order that fluid located in the chamber 16 can be directed towards the injection-valve arrangement 40.

On the side of the armature 30 (at the top in FIG. 1) remote from the stator 28 there is provided on the internal wall of the valve body 10 a magnet arrangement 42 formed from permanent magnets, which pulls the armature 30—when excitation coils 32a, 32b, 32c are not supplied with current—into the inoperative position thereof (at the top in FIG. 1) and in the process moves the piston 18 out of the chamber 16 in the sense of an enlargement of the volume of the chamber 16.

The chamber 16 is separated from the actual injection-valve arrangement 40 by a partition 42 [sic]. Nevertheless, the chamber 16 with the piston 18 and with the electromagnet arrangement 28, 30, 32 moving it, on the one hand, and the adjoining injection-valve arrangement 40 are configured as an assembly that is capable of being manipulated jointly.

The injection-valve arrangement 40 has an actuating device, described in detail further below, which acts on a movable valve member 46 of the injection-valve arrangement 40. As a result, the valve member 46 is moved between an open position and a closed position in relation to a fixed valve seat 48 interacting with the valve member 46 and arranged downstream relative to the fluid inlet 12 (up and down in FIG. 1).

The actuating device 44 is formed by an electromagnet-coil arrangement 44a, a soft-magnetic magnet-yoke arrangement 44b interacting with said electromagnet-coil arrangement, and also a soft-magnetic magnet-armature arrangement 44c interacting with said magnet-yoke arrangement. In this connection the soft-magnetic magnet-yoke arrangement 44b is formed from two circular cylindrical halves 44b′ and 44b″ with elongated recesses, arranged alongside one another, for corresponding excitation coils of the electromagnet-coil arrangement 44a. In each of the recesses an excitation coil is received which terminates flush with the respective end faces 72a, 72b of the shell halves 44b′ and 44b″.

The end faces 46a, 46b of the magnet-yoke halves 44b′ and 44b″ delimit a cavity 50 in which the magnet-armature arrangement 24c is received so as to be capable of moving along the central axis M.

The magnet-yoke arrangement here may be formed from one-piece soft iron, out of which the pole bars and the interspaces have been shaped. Recesses in the form of slots, flutes extending lengthwise in top view, or elongated holes, may be sunk into a one-piece soft-iron shaped piece of such a type. But it is also possible to produce the magnet-yoke arrangement as a shaped piece from sintered iron powder, or to assemble it from several constituent parts and, where appropriate, to bond it together with adhesive.

The magnet-armature arrangement 44c is a circular soft-iron-containing disc having a shape described in detail further below. The electromagnet-coil arrangement 44a and the magnet-armature arrangement 44c overlap in the radial direction, relative to the central axis M. As is shown in FIG. 1, the electromagnet-coil arrangement 44a has a smaller outside diameter than the armature disc 44c, so that the magnetic flux evoked from the electromagnet-coil arrangement 44a is able to penetrate the armature disc 44c practically without appreciable leakage losses. Hence a particularly efficient magnetic circuit is realised which permits very short valve-opening/closing times and also high holding forces.

The armature disc 44c may—independently of the shaping of the magnet yoke or of the magnet-coil arrangement—also be a closed circular disc made of soft iron, provided that the configuration of the magnet yoke or of the magnet-coil arrangement ensures that the leakage losses or eddy-current losses are small enough for the respective intended application. For the purpose of reducing the weight, with optimised magnetic-flux density, the armature takes the form of a multipole armature, the armature poles of which are oriented towards the respective stator poles. To this end, the armature poles are formed by diminutions and thickenings of the armature plate which otherwise substantially follows the contour of the end face of the totality of all the pole bars.

As illustrated in FIG. 1, the armature disc 44c is rigidly connected to a valve-member is actuating rod 52 and is received in longitudinally mobile manner in a working space 56 delimited by the shell halves 44b′ and 44b″ of the magnet-yoke arrangement 44b along the central axis M, guided in a tubular nozzle-holder 60. At the end of the nozzle-holder 60 there is arranged a valve arrangement consisting of the valve member 46 and the valve seat 48, in order to eject the fuel in controlled manner. The valve arrangement is formed by a valve seat which is located at the end (the lower end in FIG. 1) of the nozzle-holder 60 and which widens conically in the direction of flow, and also by an appropriately shaped valve member interacting with the valve seat. In this connection the armature disc 44c with the actuating rod 52 is loaded by a helical spring 62 arranged coaxially relative to the central axis M, so that the valve member 46 located at the end of the actuating rod 22 is seated in the valve seat 48 in fluid-tight manner—that is to say, it is pushed into its closed position. When the (lower, in FIG. 1) coils of the electromagnet-coil arrangement 44a are supplied with current, in the magnet-yoke arrangement 44b a low-eddy-current magnetic field is induced which pulls the armature disc 44c with the actuating rod 52 in the direction of the respective shell half 44b′, 44b″ in which the coil supplied with current is located. Hence the valve member 46 moves away from the valve seat 48 into its open position. When the other coil of the electromagnet-coil arrangement 44a is supplied with current, the valve member 46 moves into the respective other position, towards the valve seat 48 into its closed position.

Hence fluid coming from the fluid inlet 12 and placed under high pressure in the chamber 16 by the piston 18 is ejected from the injection-valve arrangement 40 in controlled manner through the valve member 46—or, to be more exact, through the valve seat 48—into the combustion space of the internal-combustion engine. In this connection it may be a question either of the combustion space of a spark-ignited internal-combustion engine, or of the combustion space of a self-igniting internal-combustion engine.

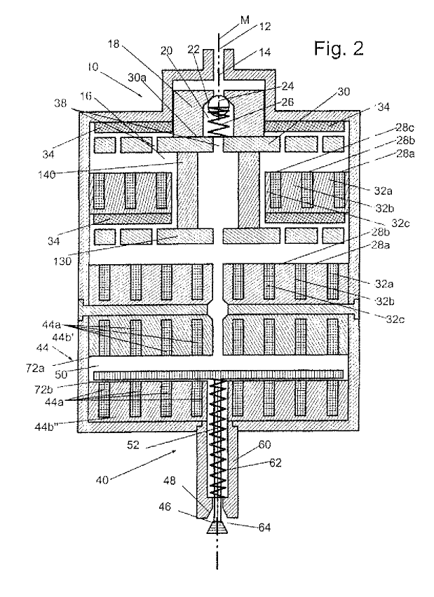

In FIG. 2 a further embodiment is illustrated, in which, for the purpose of increasing the maximum pressure that is generated in the chamber 16, two electromagnet arrangements 28, 30, 32 and 128, 130, 132 acting on the piston 18 are provided. In this connection the two armatures 30, 130 are rigidly connected to one another by means of a tube 140. The respectively associated stators 28, 128 act in the same direction on the armatures and, in the case of a supply of current to the respective excitation coils 32, 132, pull the armatures, and with them the piston 18, into the interior of the chamber 16 (downwards in FIG. 2). Hence the force for generating the pressure, and hence the pressure itself in the fluid, can be increased. It will be understood that also more than two electromagnet arrangements acting on the piston 18 may be provided. Equally, two or more actuating devices 44 may also be provided which act on the valve member 46 of the injection-valve arrangement 40. In this connection, electromagnet arrangements acting on the piston 18, and actuating devices 44 acting on the valve member 46, may also be cascaded, in particular for the purpose of realising particularly slender designs.

In other respects, in FIG. 2 parts having a design and/or function comparable or identical to those in FIG. 1 have been provided with matching reference symbols and have not been described separately once more.

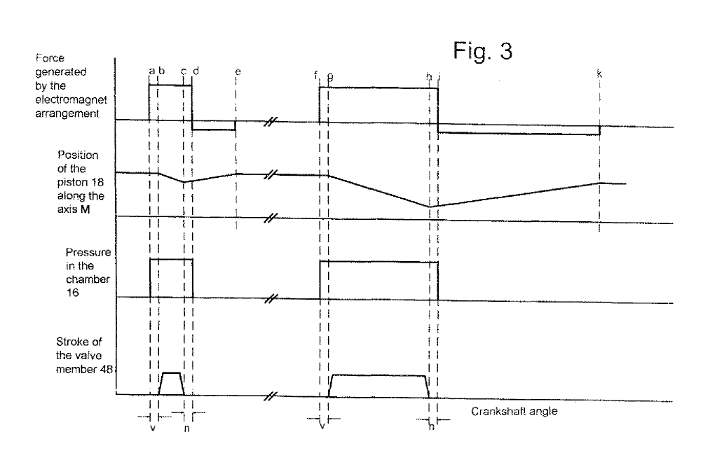

In FIG. 3 the operation of the pressure-increasing fuel-injection valve according to the invention is illustrated graphically. To this end, the crankshaft angle of the internal-combustion engine has been plotted on the abscissa of the four graphs. The ordinate of the first (uppermost) graph shows the force generated by the electromagnet arrangement 28, 30, 32 which acts on the piston 18 when the excitation coil is supplied with current. Firstly, starting from point a, when the excitation coil is supplied with current the force rises abruptly from zero to a maximum value. As a result, the piston presses on the fluid in the chamber and generates a constant pressure in the fluid (see third graph from the top). However, since the valve member 46 is still held in its closed position by its actuating device and the fluid is incompressible, the position of the piston along the central longitudinal axis M in the chamber does not change. After a pre-actuation time V, at point b the valve member 46 is brought into its open position by its actuating device. In this connection the piston is pulled into the chamber, and its position changes (see second graph from the top). When at point c the piston has executed its excursion into the chamber, the injection of the fluid is concluded and the valve member 46 is brought back into its closed position by its actuating device (see bottom graph). After a post-actuation time n which is concluded at point d, the force on the piston subsides, and the permanent magnet begins to guide the armature—and hence the piston—back into its upper position, which it reaches at point e. Subsequently the cycle can begin again anew. This is illustrated on the basis of the sequence between points f to k for a relatively long injection, in the course of which the piston is pulled further into the chamber 16 by the electromagnet arrangement 28, 30, 32. In other respects, however, the operation proceeds in a manner identical to that between points a and e.

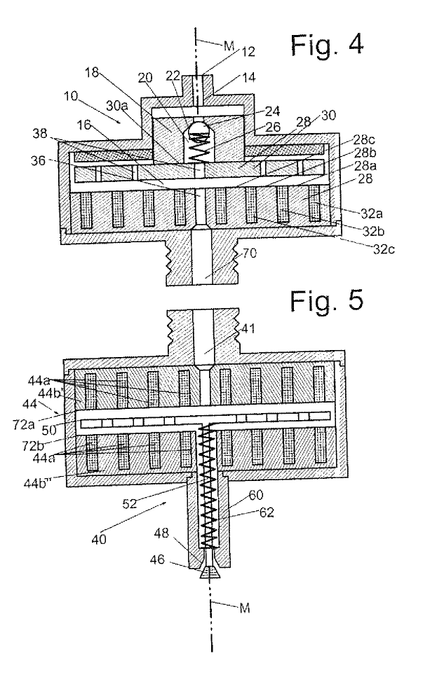

In FIG. 4 a further embodiment of a fluid-pressure generator according to the invention with a housing 10 which is substantially rotationally symmetrical relative to a central longitudinal axis M is shown in schematic longitudinal section. The fluid-pressure generator has (at the top in FIG. 4) a central fluid inlet 12, through which fluid is able to flow into the fluid-pressure generator. However, it is also possible to provide the fluid inlet 12 at the side in the upper region of the fuel-injection valve in FIG. 4. From the fluid inlet 12 a central fuel duct 14 extends to a chamber 16. The central fluid duct 14 has a circular cross-section and is widened towards the chamber 16. In the widened section of the fluid duct 14 a circular cylindrical piston 18 which projects into the chamber 16 is guided in displaceable and fluid-tight manner. As a result of a displacement of the piston 18 along the central longitudinal axis M, the volume of the chamber 16 is changed.

Arranged centrally in the piston 18 is a fluid conduit 20 which widens conically—viewed in the direction of flow of the fluid—in order to form a valve seat 22 for a valve member 24 configured in this embodiment as a ball, which is pushed against the valve seat 22 by means of a helical spring 26. Hence a check valve 22, 24, 26 is formed, by means of which an emergence of fluid located in the chamber 16 back in the direction of the fluid inlet 12 is prevented.

The piston 18 is to be actuated by an electromagnet arrangement in the sense of a diminution of the volume of the chamber 16. To this end, the electromagnet arrangement 28, 30, 32 has a stator 28, arranged in the interior of the chamber 16 and shaped from soft iron (plates) having a substantially circular cylindrical shape, and a substantially circular cylindrical, disc-shaped armature 30, likewise arranged in the interior of the chamber 16. On its one (upper in FIG. 4) end face the armature 30 is rigidly connected to the displaceable piston 18. In this connection the stator 28 takes the form of a multipole stator with stator poles extending parallel to one another and arranged alongside one another, which exhibits several excitation coils 32a, 32b, 32c assigned to the respective stator poles 28a, 28b, 28c and arranged between, in each instance, two stator poles. Hence the armature 30, and with it the piston 18, is able to move along the central longitudinal axis M. Between the stator 28 and the armature 30 there is formed a working air gap 34 oriented transversely relative to the direction of motion of the armature 30. In this connection the difference between the minimal and maximal extents of the working air gap along the central longitudinal axis M represents the measurement by which the displaceable piston 18 plunges into the chamber and pressurises fluid located therein.

On the side of the armature 30 remote from the stator 28 (at the top in FIG. 4) there is provided on the internal wall of the valve body 10 a magnet arrangement 42 formed from permanent magnets, which pulls the armature 30—when excitation coils 32a, 32b, 32c are not supplied with current—into the inoperative position thereof (upwards in FIG. 4) and in the process moves the piston 18 out of the chamber 16 in the sense of an enlargement of the volume of the chamber 16.

The stator 28 and the armature 30 each have one or more fluid ducts 36, 38, in order that fluid located in the chamber 16 is able to get through a line coupling 70 in flow communication with the chamber 16 via a pressure-resistant line—not illustrated in any detail—to an injection-valve arrangement 40 which is illustrated in one possible embodiment in FIG. 5.

The injection-valve arrangement 40 has an inlet 41 and an actuating device 44, described in detail further below, which acts on a movable valve member 46 of the injection-valve arrangement 40. As a result, the valve member 46 is moved between an open position and a closed position in relation to a fixed valve seat 48 interacting with the valve member 46 and arranged downstream relative to the inlet 41 (up and down in FIG. 5).

The actuating device 44 is formed by an electromagnet-coil arrangement 44a, a soft-magnetic magnet-yoke arrangement 44b interacting with said electromagnet-coil arrangement, and also a soft-magnetic magnet-armature arrangement 44c interacting with said magnet-yoke arrangement. In this connection the soft-magnetic magnet-yoke arrangement 44b is formed from two circular cylindrical halves 44b′ and 44b″ with recesses, extending alongside one another and arranged in parallel, for corresponding excitation coils of the electromagnet-coil arrangement 44a. In each of the recesses surrounding the pole bars an excitation coil is received which terminates flush with the respective end faces 72a, 72b of the shell halves 44b′ and 44b″. The end faces 46a, 46b of the magnet-yoke halves 44b′ and 44b″ delimit a cavity 50 in which the magnet-armature arrangement 24c is received so as to be capable of moving along the central axis M.

The magnet-yoke arrangement here may be formed from one-piece soft iron, out of which the pole bars and the interspaces have been shaped. Into a one-piece soft-iron shaped piece of such a type there may be sunk interruptions in the form of slots or elongated holes which are filled with electrically insulating material. But it is also possible to produce the magnet-yoke arrangement as a shaped piece from sintered iron powder, or to assemble it from several constituent pieces which are insulated in relation to one another, and, where appropriate, to bond it together with adhesive.

The magnet-armature arrangement 44c is a circular soft-iron-containing disc having a shape described in detail further below. The electromagnet-coil arrangement 44a and the magnet-armature arrangement 44c overlap in the radial direction relative to the central axis M. As is shown in FIG. 5, the electromagnet-coil arrangement 44a has a smaller outside diameter than the armature disc 44c, so that the magnetic flux evoked from the electromagnet-coil arrangement 44a is able to penetrate the armature disc 44c practically without appreciable leakage losses. Hence a particularly efficient magnetic circuit is realised which permits very small valve-opening/closing times and also high holding forces.

The armature disc 44c may—independently of the shaping of the magnet yoke or of the magnet-coil arrangement—also be a closed circular disc made of soft iron, provided that the configuration of the magnet yoke or of the magnet-coil arrangement ensures that the leakage losses or eddy-current losses are small enough for the respective intended application. As illustrated in FIG. 5, the armature disc 44c is rigidly connected to a valve-member actuating rod 52 and is received in longitudinally mobile manner in a working space 56 delimited by the shell halves 44b′ and 44b″ of the magnet-yoke arrangement 44b along the central axis M, guided in a tubular nozzle-holder 60. At the end of the nozzle-holder 60 there is arranged a valve arrangement consisting of the valve member 46 and the valve seat 48, in order to eject the fuel in controlled manner. The valve arrangement is formed by a valve seat, which is located at the (lower, in FIG. 5) end of the nozzle-holder 60 and which widens conically in the direction of flow, and also by an appropriately shaped valve member interacting with the valve seat. In this connection the armature disc 44c with the actuating rod 52 is loaded by a helical spring 62 arranged coaxially relative to the central axis M, so that the valve member 46 located at the end of the actuating rod 52 is seated in the valve seat 48 in fluid-tight manner—that is to say, it is pushed into its closed position. When the (lower, in FIG. 5) coils of the electromagnet-coil arrangement 44a are supplied with current, a low-eddy-current magnetic field is induced in the magnet-yoke arrangement 44b, which pulls the armature disc 44c with the actuating rod 22 in the direction of the respective shell half 44b′, 44b″ in which the coil supplied with current is located. Hence the valve member 46 moves away from the valve seat 48 into its open position. When the other coil of the electromagnet-coil arrangement 44a is supplied with current, the valve member 46 moves into the respective other position, towards the valve seat 48 into its closed position.

Hence fluid under high pressure arriving at the inlet 41 is ejected from the injection-valve arrangement 40 in controlled manner through the valve member 46—or, to be more exact, through the valve seat 48—into the combustion space of the internal-combustion engine.

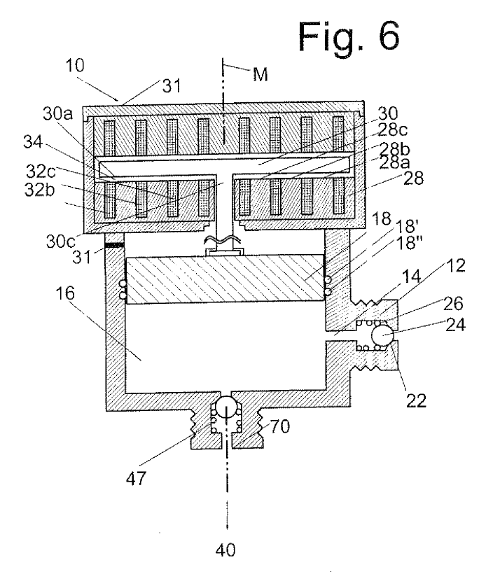

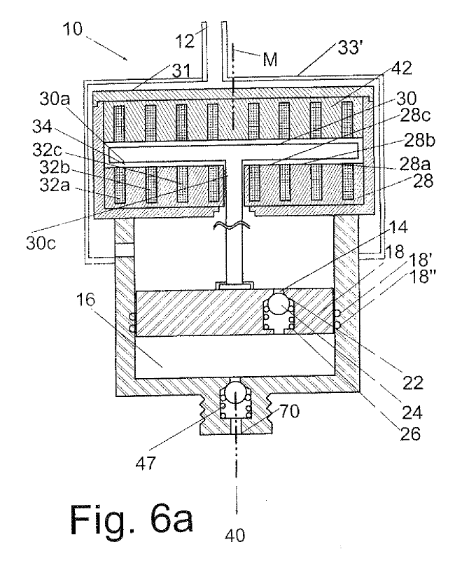

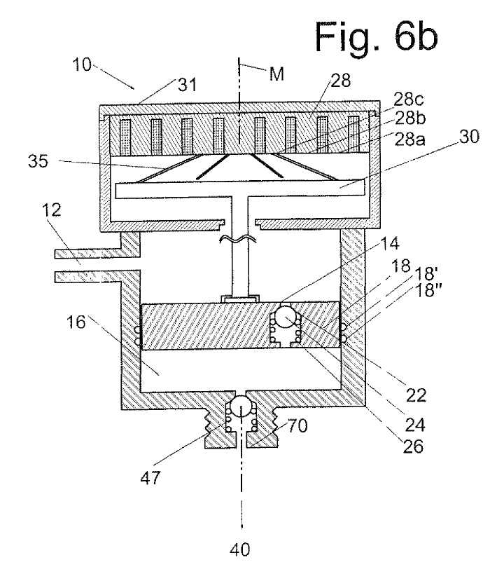

In FIG. 6 a further embodiment of a fluid-pressure generator according to the invention is shown in schematic longitudinal section with a housing 10 which is substantially rotationally symmetrical relative to a central longitudinal axis M. The fluid-pressure generator has a fluid inlet 12 at the side, through which fluid is able to flow into the fluid-pressure generator. From the fluid inlet 12 a fuel duct 14 extends to a chamber 16. Into the chamber 16 there extends a circular cylindrical piston 18 which is guided therein in displaceable and fluid-tight manner by means of two O-ring seals 18′, 18″. As a result of a displacement of the piston 18 along the central longitudinal axis M, the volume of the chamber 16 is changed.

The fluid inlet 12 is widened, in order to form a valve seat 22 for a valve member 24 configured as a ball, which by means of a helical spring 26 is pushed against the valve seat 22. Hence a check valve 22, 24, 26 is formed, by means of which an emergence of fluid located in the chamber 16 back in the direction of the fluid inlet 12 is prevented.

The piston 18 is to be actuated by an electromagnet arrangement in the sense of a diminution of the volume of the chamber 16. To this end, the electromagnet arrangement 28, 30, 32 has a stator 28 arranged outside the chamber 16 in a separate housing 31 and shaped from soft iron (plates) having substantially circular cylindrical shape, and a substantially circular cylindrical, disc-shaped armature 30 which is likewise arranged in the housing 31. On its one (lower, in FIG. 6) end face 30b the armature 30 is rigidly connected to the displaceable piston 18 by means of a rod 30c.

In this connection the stator 28 takes the form of a multipole stator with elongated stator poles 28a, 28b, 28c arranged alongside one another with a spacing. The multipole stator 28 exhibits several excitation coils 32a, 32b, 32c assigned to the respective stator poles 28a, 28b, 28c and arranged surrounding the stator poles. Hence when current is supplied to the excitation coils 32a, 32b, 32c the armature 30, and with it the piston 18, is able to move along the central longitudinal axis M. Between the stator 28 and the armature 30 there is formed a working air gap 34 oriented transversely relative to the direction of motion of the armature 30. In this connection the difference between the minimal and the maximal extents of the working air gap along the central longitudinal axis M represents the measurement by which the displaceable piston 18 plunges into the chamber and pressurises fluid located therein.

On the side of the armature 30 remote from the stator 28 (at the top in FIG. 6) there is provided on the internal wall of the housing 31 an electromagnet arrangement 42 which is mirror-inverted relative to the electromagnet arrangement 28, 30, 32 and which pulls the armature 30 into the inoperative position thereof (upwards in FIG. 6) and in the process moves the piston 18 out of the chamber 16 in the sense of an enlargement of the volume of the chamber 16. Instead of, or in addition to, the upper electromagnet arrangement 42, which moves the piston out of the chamber 16, a spring arrangement—for example, in the form of a diaphragm spring, helical spring or conical spring—may also be provided, in order to move the piston out of the chamber 16. It will be understood that this alternative can also be employed in all the other embodiments of the invention elucidated here.

By means of a conduit 31 above the piston 18 (on the low-pressure side thereof) in the wall of the housing 30, an exchange of air with the environment and also, where appropriate, an emergence of fluid that has penetrated into the space above the piston 18 is made possible.

Shown in schematic longitudinal section in FIG. 6a is a further embodiment of a fluid-pressure generator according to the invention, which in some details coincides with the embodiment from FIG. 6. Therefore only relevant differences in relation to FIG. 6 will be elucidated in the following. In the embodiment according to FIG. 6a there is provision that the fluid flows in through a n inlet 12 into a hollow encasement 33′ of the housing 31 of the pressure-generator. Hence it can be ensured that the fluid cools the pressure-generator. From the hollow encasement 33′ the fluid is able to flow in on the side of the piston 18 facing away from the chamber 16 and is able to get into the chamber 16 through a check-valve arrangement 22, 24, 26 in the piston 18 if the electromagnet arrangement actuates the piston 18 in the sense of an enlargement of the volume of the chamber 16. To this end, in the piston 18 a conduit is provided which exhibits a valve seat 22 for a valve member 24 configured as a ball, which is pressed against the valve seat 22 by means of a helical spring 26. By means of the check valve 22, 24, 26 an emergence of fluid located in the chamber 16 back in the direction of the fluid inlet 12 is prevented. The region in which the armature 30 is located is therefore filled by the inflowing fluid. This has the advantage, not least, that the electromagnet arrangement as a whole is cooled by the fluid. In advantageous manner the armature 30—which is also capable of being configured as a multipole armature—has conduits, not illustrated in any detail, so that fluid surrounding it does not impair, or barely impairs, the motion of the armature.

The piston 18 is to be actuated by the electromagnet arrangement 32b, 32c in the sense of a diminution of the volume of the chamber 16. To this end, on the side of the armature 30 remote from the stator 28 (at the top in FIG. 6) there is provided on the internal wall of the housing 31 an electromagnet arrangement 42 which is mirror-inverted relative to the electromagnet arrangement 28, 30, 32 and which pulls the armature 30 into the inoperative position thereof (upwards in FIG. 6) and in the process moves the piston 18 out of the chamber 16 in the sense of an enlargement of the volume of the chamber 16.

In FIG. 6b a further embodiment of a fluid-pressure generator according to the invention is illustrated which in its structure resembles the fluid-pressure generators from FIGS. 6, 6a in a number of details. Therefore only the differences in relation to these embodiments will be elucidated in the following.

One difference in relation to the embodiment according to FIG. 6 consists in that the armature 30 is to be transported into a retracted position thereof (for example, at the top in FIG. 6b) by means of an electromagnet arrangement 28. At the same time, when the armature is attracted to the electromagnet arrangement a spring arrangement 35 in the form of a diaphragm spring supporting the armature against the electromagnet arrangement is placed in its tensioned state. This spring arrangement 35 has the effect that in the case of a currentless electromagnet arrangement the armature 30 is pushed into its second—advanced—position (for example, at the bottom in FIG. 6b). This has the consequence that the piston 18 reduces the volume of the chamber 16 in the sense of a displacement of fluid out of the chamber 16. It will be understood that tension-spring arrangements may also be employed instead of the diaphragm-spring arrangement 35 shown here operating as a compression spring. This alternative is also capable of being combined with the other embodiments of the invention elucidated here. Lastly, the principle shown in FIG. 6b, namely loading a spring storage device simultaneously with the motion of the armature, can also be employed in the reverse direction. This means that an electromagnet arrangement attracts the armature in the sense of a diminution of the volume of the chamber 16 and simultaneously tensions a spring arrangement. With a currentless electromagnet arrangement, the spring arrangement then transports the armature 30—and hence the piston 18—in the sense of an enlargement of the volume of the chamber 16 (for example, upwards again in FIG. 5b).

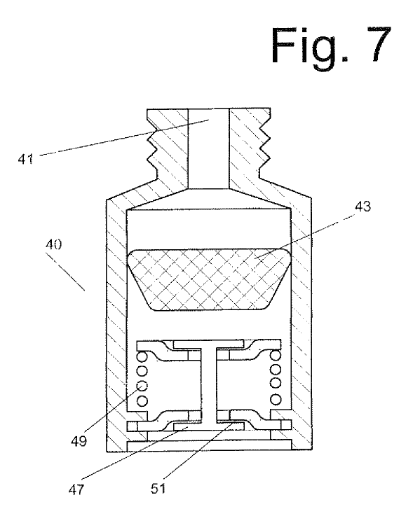

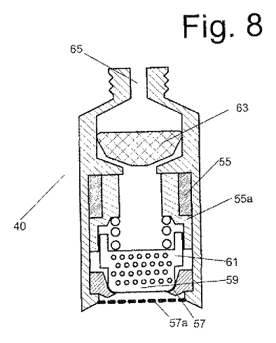

In all the embodiments shown in FIGS. 6, 6a, 6b, fluid located in the chamber is able to reach an injection-valve arrangement 40, which is illustrated in FIGS. 7 and 8 in further possible embodiments, through a line coupling 70 in flow communication with the chamber 16 via a pressure-resistant line which is not illustrated in any detail. A further check-valve arrangement 47, similar to that at the entrance to the chamber 16, is provided in the flow connection to the injection-valve arrangement 40—for example, in the line coupling 70. By this means, fluid is to be prevented from flowing back into the chamber 16 through the line coupling 70. Of course, the injection-valve arrangements 40 may also be connected directly, i.e. without a pressure-resistant line, to one of the embodiments of fluid-pressure generators according to the invention.

In both of these embodiments shown in FIGS. 7, 8 it is a question of conventional injection-valve arrangements 40 such as are also offered for sale by Robert BOSCH GmbH, for example. In detail, it may be a question of types pertaining to the BOSCH EV series, or of others.

In FIG. 7 an injection-valve arrangement 40 is shown which opens automatically at a certain fluid overpressure at its inlet 41; so it has no metering function. This injection-valve arrangement 40 has a fine-screen filter 43 located downstream relative to the inlet 41, through which the fluid reaches a plate-type valve member 47 which is biased into a closed position by a helical spring 49. As soon as fluid under pressure is queued at the inlet 41, the plate-type valve member 47 lifts off from its seat 51 and allows the fluid to emerge. If the fluid pressure “breaks down”, the plate-type valve member 47 rests on its seat 51 again, and the outflow of fluid is prohibited.

In FIG. 8 an injection-valve arrangement 40 is shown which is configured as an electromagnetic injection valve. This electromagnetic injection valve has, in a housing 53, a cylindrical current coil 55 in a magnet yoke 55a with not illustrated in any detail—electrical terminals, a valve seat 57 with a n injection-orifice disc 57a and a movable valve needle 59 with a magnet armature 61. A fine-screen filter 63 in the fluid inlet 65 protects the injection valve against contamination. In the case of a currentless current coil 55, the valve needle 59 is pushed onto the valve seat 57 by a force resulting from a helical spring 65 [sic] resting on the valve needle 59 and from the fluid pressure. In the case of a current coil 55 supplied with current, the valve needle 59 is attracted by a magnetic field generated by the current coil 55 and acting on the magnet armature 61, so that the valve needle 59 lifts off from the valve seat 57 and the fluid flows out through the injection valve. The quantity of fluid injected out per unit of time is substantially determined by the fluid pressure at the fluid inlet 65 and by the free cross-section of the openings in the injection-orifice disc. If the excitation current of the current coil 55 is deactivated, the injection valve closes again.

The embodiments that have been elucidated in the above description of the invention, and the individual aspects thereof, are of course capable of being combined with one another, even if combinations of such a type have not been elucidated above in detail.

1. A fluid-pressure generator, in order to generate an increased pressure-level in fluids at high speed in a small construction space, with
an inlet (12) which is adapted to receive fluid from a supply line and which is connected to a chamber (16),
a fluid outlet (64) which is connected to the chamber (16) and which is adapted to allow fluid to flow out of the fluid-pressure generator,
a displaceable piston (18) projecting into the chamber (16), which is adapted to change the volume of the chamber (16), and
an electromagnet arrangement (28, 30, 32) by which the piston (18) is to be actuated in the sense of a diminution of volume, wherein
the electromagnet arrangement exhibits a stator (28) and an armature (30), and
the stator (28) takes the form of a multipole stator with one or more stator poles and exhibits excitation coils (32a, 32b, 32c) assigned to the respective stator poles.

2. The fluid-pressure generator according to claim 1, wherein
a check valve (22, 24) is provided, by means of which an emergence of fluid located in the chamber (16) in the direction of the fluid inlet (12) is prevented.

3. The fluid-pressure generator according to claim 2, wherein
the check valve (22, 24) is arranged in the flow duct (14).

4. The fluid-pressure generator according to claim 2, wherein
the check valve (22, 24) is arranged in the displaceable piston (18), preferably in a fuel conduit (20) located therein.

5. The fluid-pressure generator according to claim 1, wherein
the multipole stator (28) is designed with several stator poles arranged alongside one another with a spacing, which [sic] exhibits several excitation coils (32a, 32b, 32c) assigned to the respective stator poles (28a, 28b, 28c) and arranged between, in each instance, two stator poles.

6. The fluid-pressure generator according to claim 1, wherein
the armature (30) is connected to the displaceable piston (18) or is a part thereof.

7. The fluid-pressure generator according to claim 1, wherein
the armature (30) takes the form of a multipole armature, the armature poles of which are oriented towards the respective stator poles (28a, 28b, 28c).

8. The fluid-pressure generator according to claim 1, wherein
the electromagnet arrangement exhibits a working air gap (34), preferably oriented transversely relative to the direction of motion of the armature (30), between the stator (28) and the armature (30).

9. The fluid-pressure generator according to claim 1, wherein
the stator (28) and/or the armature (30) is/are arranged in the interior of the chamber (16).

10. The fluid-pressure generator according to claim 1, wherein
the stator (28) and/or the armature (30) exhibit(s) at least one fluid duct (36, 38) for fluid in the direction towards an ejection-valve arrangement (40).

11. The fluid-pressure generator according to claim 1, wherein
on a side of the armature (30) remote from the stator (28) a magnet arrangement (42), preferably exhibiting permanent magnets, is provided which transports the armature (30) into the inoperative position thereof and in the process pushes the piston (18) out of the chamber (16) in the sense of an enlargement of the volume of the chamber (16).

12. The fluid-pressure generator according to claim 1, wherein
the chamber (16), the ejection-valve arrangement (40), the piston (17) and the electromagnet arrangement (28, 30, 32) are configured as an assembly that is capable of being manipulated jointly.

13. The fluid-pressure generator according to claim 1 wherein
the actuating device acts on a movable valve member (46) of the valve arrangement (46, 48), in order to move said valve member between an open position and a closed position in relation to a fixed valve seat (48) interacting with the valve member (46) and arranged downstream relative to the fluid inlet (12).

14. The fluid-pressure generator according to claim 1, wherein
several actuating devices (44) acting on the valve arrangement (46, 48) and/or several electromagnet arrangements (28, 30, 32) acting on the piston (18) are provided.

15. The fluid-pressure generator according to claim 1, wherein
the actuating devices (44) exhibit a magnet-yoke arrangement (44b) consisting of two approximately circular cylindrical halves (44b′, 44b″) with pole bars which are arranged substantially alongside one another with a spacing and which are surrounded by recesses, an excitation coil of the electromagnet-coil arrangement (44a), which terminates flush with respective end faces (72a, 72b) of the shell halves (44b′, 44b″), being received in each of the recesses.

16. The fluid-pressure generator according to claim 1, wherein
the ejection-valve arrangement (40) is connected to the fluid outlet (64) of the fluid-pressure generator via a fluid line.

17. The fluid-pressure generator according to claim 1, characterised in that it is adapted and dimensioned as a fuel-injection valve, in order to project into the combustion space of a spark-ignited or a self-igniting internal-combustion engine.
